(19) United States
(12) Patent Application Publication
(10) Pub. No.: US 2023/0226882 A1
(43) Pub. Date: Jul. 20, 2023

(54) SOLAR LOAD FEEDBACK FOR CLIMATE CONTROL

(71) Applicants: Hyundai Motor Company, Seoul (KR); Kia Corporation, Seoul (KR)

(72) Inventor: Lee Foster, Tehachapi, CA (US)

(21) Appl. No.: 17/577,750

(22) Filed: Jan. 18, 2022

(51) Int. Cl. B60H 1/00; G01J 1/42

(52) U.S. Cl. CPC B60H 1/0075; G01J 1/42; G01J 2001/4266

(57) ABSTRACT

Methods and systems are described for vehicle range predictors. The system determines a change in mass to a vehicle while driving and calculates a vehicle load in response to determining the change in mass. The system then adjusts a vehicle range in response to calculating the vehicle load. The vehicle range is indicative of a distance in which the vehicle is predicted to travel with a remaining fuel. The adjusted vehicle range is based on the vehicle load.

### TECHNICAL FIELD

The present disclosure relates generally to vehicles, and more particularly, to solar load feedback for climate control systems.

### BACKGROUND

A climate control system may monitor the temperature inside of a vehicle and maintain the temperature at a fixed level. But light entering a vehicle can change the temperature inside of the vehicle. The light entering the vehicle may make the inside of the vehicle hot, causing discomfort to passengers. The climate control system may have a delayed response to the change in temperature caused by the light entering the vehicle. This delayed response causes unnecessary discomfort due to the delayed adjustments to the climate control system settings. Furthermore, the delayed response may result in overcompensating for the increased temperature, leading to a cooler temperature than desired after a prolonged period of time. More worrisome, the climate control system may not respond to the change in temperature caused by the light entering the vehicle.

### SUMMARY

The present disclosure provides methods, systems, articles of manufacture, including computer program products, for solar load feedback for a climate control system.

In one aspect, there is provided a system including at least one processor and at least one memory. The at least one memory may store instructions. When executed by the at least one data processor, the instructions may cause the at least one data processor to at least calculate a solar load based on data from the camera in response to a camera determining a change in an amount of light entering a vehicle, the solar load indicative of an intensity of light entering the vehicle; and in response to calculating the solar load, adjusting a climate control system in the vehicle based on the solar load and a target temperature within the vehicle, the climate control system configured to maintain the target temperature.

In some variations, one or more of the features disclosed herein including the following features may optionally be included in any feasible combination. Additionally, the camera is an advanced driver assistance camera with a light meter configured to adjust an iris setting associated with a lens of the camera, the iris setting indicative of the solar load, and wherein data from the camera is the iris setting. The solar load is calculated based on light setting data from the camera and the light setting data is converted to the solar load using a transfer function. In some variations, calculating the solar load includes calculating the intensity of light entering the vehicle based on at least one of aperture setting data from the camera, ISO setting data from the camera, and shutter speed data from the camera. The calculating of the solar load is further based on measuring the intensity of light traveling at ultraviolet frequencies.

Additionally, calculating the solar load is further based on measuring the intensity of light traveling at infrared frequencies. In some variations, calculating the solar load is further based on measuring the intensity of light traveling at visible-light frequencies. In some variations, wherein the camera determines the change in light entering the vehicle based on at least one of an iris setting, a light setting, an ISO setting, an aperture setting, and a shutter speed.

Further, adjusting the climate control system includes at least one of adjusting an applied blower motor voltage, an intake door, a compressor setting, a ventilation mode, and an air temperature leaving a vent. In some variations, the climate control system adjusts to a cooler temperature setting based on a higher solar load and wherein the climate control system adjusts to a higher temperature setting based on a lower solar load.

Implementations of the current subject matter may include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer-implemented methods consistent with one or more implementations of the current subject matter can be implemented by one or more data processors residing in a single computing system or multiple computing systems.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 depicts an example of a flowchart with feedback for adjusting a climate control system in a vehicle based on a solar load and a target temperature within the vehicle;

FIG. 2A depicts an example of a position for placing the camera configured to determine a change in light entering the vehicle;

FIG. 2B depicts another example of a position for placing the camera configured to determine a change in light entering the vehicle;

FIG. 3 depicts an example of a graph showing the sensitivity of the camera to different wavelengths of light in comparison to human perception;

FIG. 4 depicts an example of a diagram illustrating the inputs and outputs to the climate control system with feedback capabilities for maintaining a target temperature;

FIG. 5 depicts an example of a graph illustrating the behavior of the climate control system in response to the change in light entering the vehicle;

FIG. 6 depicts a diagram of a graph illustrating the relationship between the climate control system gain and the solar load on the vehicle; and

FIG. 7 depicts a block diagram illustrating a computing system consistent with implementations of the current subject matter.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiments are described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present embodiments may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

A climate control system may be adjusted in response to determining a change in light entering the vehicle. The climate control system may be configured to maintain a target temperature within the vehicle. Adjusting the climate control system enables the target temperature to be maintained as increased light (e.g., sunlight) enters the vehicle. The camera is configured to determine the change in light entering the vehicle.

A solar load may be calculated based on data from the camera. The solar load may be indicative of an intensity of light entering the vehicle. The greater the solar load, the greater the heating effect the incoming light will have on the interior of the cabin. The climate control system may counteract the heating effect of the incoming light by adjusting a setting. For example, the climate control system may adjust to a cooler temperature setting based on a higher solar load. The climate control system may also be adjusting by modifying an applied blower motor voltage, an intake door, a compressor setting, a ventilation mode, or an air temperature leaving a vent.

The solar load may be calculated based on light setting data from the camera. The camera may include a light meter to adjust an iris setting associated with the lens of the camera. The iris setting may be indicative of the solar load. In some embodiments, the solar load may be calculated based on aperture setting data from the camera and shutter speed data from the camera. The camera may determine the change in light entering the vehicle based on at least one of an iris setting, a light setting, an aperture setting, a shutter speed.

The methods, systems, apparatuses, and non-transitory storage mediums described herein adjust a climate control system in response to determining a change in light entering the vehicle to maintain a target temperature. The various embodiments also calculate a solar load on the vehicle based on data from the camera.

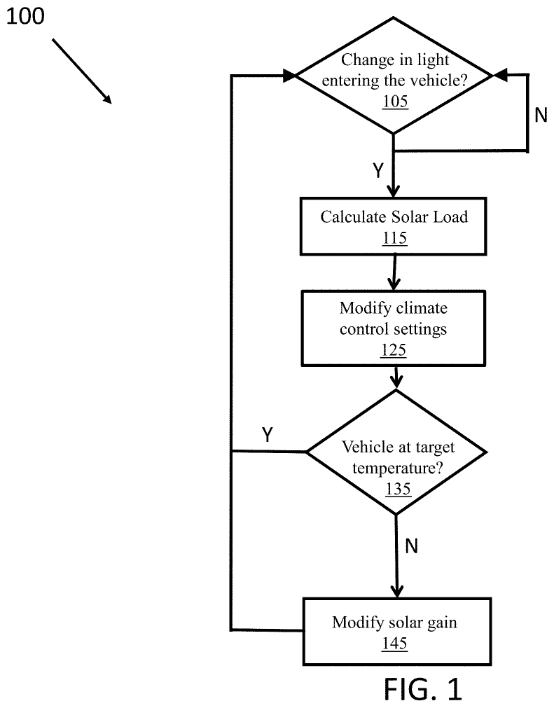

FIG. 1 depicts an example of a flowchart with feedback for adjusting a climate control system in a vehicle based on a solar load and a target temperature within the vehicle. The solar load feedback flowchart 100 may determine how much the climate control system is to be adjusted. The solar load feedback flowchart 100 may continuously monitor for a change in light entering the vehicle. The solar load feedback flowchart 100 may be triggered by a signal from a vehicle sensor or a manual input from a vehicle occupant indicating that a change in light entering the vehicle may occur.

At 105, a camera may be configured to detect a change in light entering the vehicle. In particular, the camera may be configured to detect the change in light entering the vehicle based on an iris setting, a light setting, an aperture setting, an ISO setting, or a shutter speed. The iris setting, the light setting, the ISO setting, and the aperture setting may indicate that more light is entering the camera. For example, an aperture setting resulting in a smaller aperture may be the result of increased light entering the camera. In another example, the light setting may be configured to a greater amount of light, indicating that an increased amount of light is entering the camera. A greater amount of light entering the camera is indicative of a greater amount of light entering into the vehicle.

The camera may be an advanced driver assistance camera. The camera may have a light meter configured to adjust an iris setting associated with a lens of the camera. Similar to the aperture setting and the light setting, the iris setting may be indicative of the light entering into the vehicle. The camera may be more sensitive to sunlight entering the vehicle than other types of light entering the vehicle. For example, the camera may be configured to filter out headlights, streetlights, and other incoming light that has a minimal effect on the internal temperature of the vehicle.

The camera may be communicatively coupled to a processor. The processor may be communicatively coupled to a non-transitory computer-readable storage medium storing instructions. The processor may be configured to receive a data reading from the camera. The data reading may include an iris setting reading, a light setting reading, and an aperture setting reading. The processor may be configured to determine that a change in light entering the vehicle based on the data reading from the camera. Additionally, a data reading including a change to the iris setting, the light setting, or the aperture setting may indicate the light entering the vehicle changed. The non-transitory computer-readable storage medium may be configured to store data readings from the camera and compare the data readings to determine the light entering the vehicle changed. For example, an aperture setting resulting in a smaller aperture may be the result of increased light entering the camera.

At 115, the solar load may be calculated. The solar load may be indicative of an intensity of light entering the vehicle. The solar load may be calculated based on data from the camera. The solar load may be calculated based on light setting data from the camera. In particular, the solar load may be calculated based on aperture setting data from the camera. The solar load may be calculated based on shutter speed data from the camera. Additionally, the solar load may be calculated based on iris setting data from the camera. The solar load may be calculated based on an ISO setting data from the camera.

The solar load may be calculated based on aperture setting data from the camera. For example, the camera may include an aperture setting configured to adjust an aperture associated with a lens of the camera. The aperture setting may be adjusted for increased light passing through the lens of the camera. In this example, the aperture setting may correspond to a greater intensity of the solar load on the vehicle. The aperture setting may be converted to a solar load using a reference table that corresponds an aperture setting to a solar load. In some embodiments, the aperture setting data may be converted to a solar load using a transfer function.

The solar load may be calculated based on shutter speed data from the camera. For example, the camera may include a shutter speed setting associated with a lens of the camera. The shutter speed setting may be adjusted for increased light passing through the lens of the camera. In this example, the shutter speed setting may correspond to a greater intensity of the solar load on the vehicle. The shutter speed setting may be converted to a solar load using a reference table that corresponds to a shutter speed setting to a solar load. In some embodiments, the shutter speed setting data may be converted to a solar load using a transfer function.

The solar load may be calculated based on iris setting data from the camera. For example, the camera may include a light meter configured to adjust an iris setting associated with a lens of the camera. The light meter may adjust the iris setting for increased light passing through the lens of the camera. In this example, the iris setting may correspond to a greater intensity of the solar load on the vehicle. The iris setting may be converted to a solar load using a reference table that corresponds an iris setting to a solar load. In some exemplary embodiments, the iris setting data may be converted to a solar load using a transfer function.

The solar load may be calculated based on an ISO setting data from the camera. For example, the camera may include an ISO setting associated with a film of the camera. The ISO setting may be adjusted for increased light passing through the lens of the camera. In this example, the ISO setting may correspond to a greater intensity of the solar load on the vehicle. The ISO setting may be converted to a solar load using a reference table that corresponds an ISO setting to a solar load. In some exemplary embodiments, the ISO setting data may be converted to a solar load using a transfer function.

In some exemplary embodiments, the solar load may be calculated based on measuring the intensity of light traveling at infrared frequencies. Measuring infrared frequencies may be a better indicator of the amount of heat-inducing light entering the vehicle. In addition, the solar load may be calculated based on measuring the intensity of light traveling at ultraviolet frequencies. Measuring ultraviolet frequencies may be a better indicator of the amount of heat-inducing light entering the vehicle. In some exemplary embodiments, the solar load may be calculated based on measuring the intensity of light traveling at visible-light frequencies. Measuring visible-light frequencies may be a better indicator of the amount of heat-inducing light entering the vehicle.

In some exemplary embodiments, the solar load may be calculated based on an illuminance measurement. The solar load may be calculated based on settings related to light from the camera, including the illuminance. The illuminance of the light entering the camera may be solved based on data from the camera settings related to light. The illuminance of the light entering the camera may be expressed by the following equation:

N\hat{ }2/t=ES/C

wherein E is the illuminance, C is the incident-light meter calibration constant, N is the relative aperture, and t is the exposure time. The illuminance may be solved by determining camera settings. For example, the illuminance may be solved by determining the exposure time or and the aperture setting. The illuminance of the light entering the camera may determine the intensity of the solar load on the vehicle.

At 125, a climate control system may be adjusted in response to the solar load on the vehicle. The climate control system may be adjusted based on the calculated solar load and a target temperature within the vehicle. In particular, the climate control system may be adjusted by modifying an applied blower motor voltage, an intake door, a compressor setting, a ventilation mode, or an air temperature leaving a vent. The climate control system may be configured to adjust to a cooler temperature setting based on a higher solar load. The climate control system may be configured to adjust to a higher temperature setting based on a lower solar load.

The climate control system may be communicatively coupled to the camera. The climate control system may be configured to receive a calculated solar load based on the data from the camera. The data reading may include an iris setting reading, a light setting reading, and an aperture setting reading. The processor may be configured to determine that the climate control system needs to be adjusted based on the solar load determined by a data reading from the camera. For example, additional vents into the cabin of the vehicle need to be opened based on the increased solar load as indicated by an aperture setting at the camera.

At 135, the processor may be configured to determine whether the vehicle is at a target temperature. The climate control system may be configured to maintain the target temperature. The climate control system may be adjusted based on the calculated solar load and a target temperature within the vehicle. The climate control system may include a temperature sensor. The temperature sensor may be configured to obtain temperature readings of the cabin of the vehicle. In response to determining that the temperature within the vehicle is the target temperature, the processor may be configured to continue to monitor the vehicle interior for changes in an amount of light entering the vehicle. If the temperature within the vehicle has not reached the target temperature, the processor or climate control system may be configured to determine the difference between the target temperature and a temperature reading from the temperature sensor.

The climate control system may be configured to determine the difference between the target temperature and a temperature reading from the temperature sensor representative of the temperature of the cabin of the vehicle. A greater temperature difference between the target temperature and the temperature reading may result in a greater adjustment of the climate control system. For example, a greater adjustment to the climate control system may include activating an air-conditioning compressor and increasing the fan speed at the vent. A smaller temperature difference between the target temperature and the temperature reading may result in a smaller adjustment of the climate control system. For example, a smaller adjustment to the climate control system may include switching a ventilation mode from floor mode to front-facing vent mode.

At 145, the solar gain may be modified. In response to determining that the difference between the target temperature and a temperature reading from the temperature sensor increases, the solar gain may be modified. The solar gain may control the intensity of the response of the climate control system. A greater solar gain may result in a greater adjustment of the climate control system. A lesser solar gain may result in a smaller adjustment of the climate control system. After modifying the solar gain, the processor may be configured to continue monitoring the vehicle for changes in the amount of light entering the vehicle.

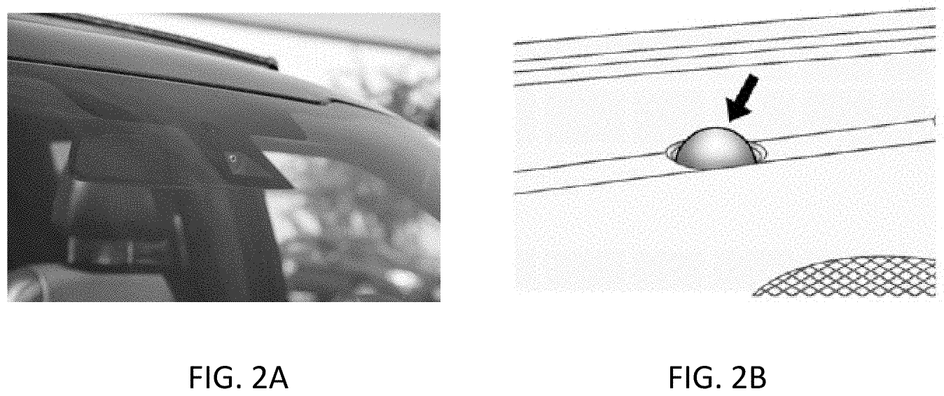

FIG. 2A depicts an example of a position for placing the camera configured to determine a change in light entering the vehicle. The camera may be disposed proximate to the windshield. The camera may be disposed behind the rear-view mirror and mounted to the windshield. The camera may be surrounded by covering with an aperture through which the lens of the camera may be exposed. The camera may be angled parallel to the ground. Additionally, camera may be angled downward toward the ground. The camera may be angled above the horizon. The camera may measure the light using Cadmium Sulfide photoresistors or silicon photodiodes (PD, or SBC).

FIG. 2B depicts another example of a position for disposed the camera configured to determine a change in the amount of light entering the vehicle. The camera may be disposed near or proximate to a glass surface through which light may enter. For example, the camera may be disposed near the windshield where the camera may be exposed to solar radiation. Alternately, the camera may be disposed near a back windshield or outside of the vehicle. The vehicle may be integrated with an advanced driver assistance camera.

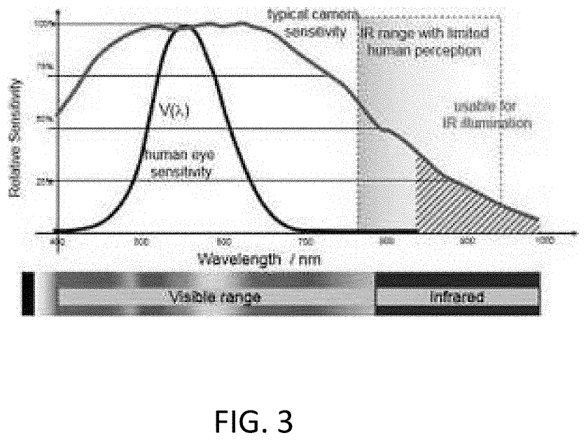

FIG. 3 depicts an example of a graph showing the sensitivity of the camera to different wavelengths of light in comparison to human perception. The camera may be sensitive to different wavelengths in the visible light wavelength range, the infrared light wavelength range, and the ultraviolet light wavelength range. The camera may be more sensitive to light traveling at different wavelengths than the human eye. For example, the camera may be more sensitive to the infrared wavelength range than the human eye.

In some embodiments, the solar load may be calculated based on measuring the intensity of light traveling at infrared frequencies. Measuring infrared frequencies may be a better indicator of the amount of heat-inducing light entering the vehicle. In some exemplary embodiments, the solar load may be calculated based on measuring the intensity of light traveling at ultraviolet frequencies. Measuring ultraviolet frequencies may be a better indicator of the amount of heat-inducing light entering the vehicle. In some exemplary embodiments, the solar load may be calculated based on measuring the intensity of light traveling at visible-light frequencies. Measuring visible-light frequencies may be a better indicator of the amount of heat-inducing light entering the vehicle.

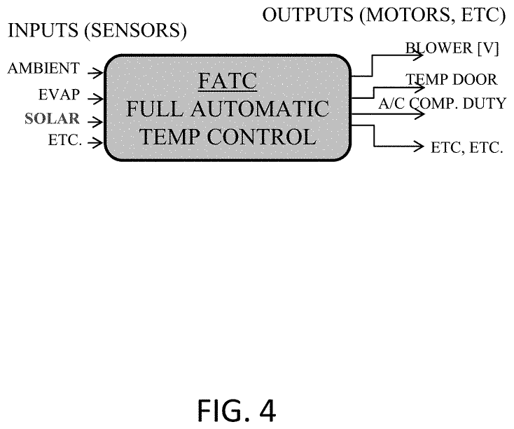

FIG. 4 depicts an example of a diagram illustrating the inputs and outputs to the climate control system with feedback capabilities for maintaining a target temperature. The climate control system may be communicatively coupled to various sensors. The sensors may provide a data reading for the climate control system. The inputs to the climate control system may include a data reading from the solar load, the ambient temperature, or the air conditioning evaporator. For example, the climate control system may be configured to receive an ambient temperature reading from the temperature sensor. In another example, the climate control system may be configured to receive a solar load calculation based on a reading from the camera.

The climate control system may be coupled to various components controlling the climate control system. The climate control system may be configured to operate a blower motor voltage configured to adjust a speed at which the blower motor operates. The climate control system may be configured to operate an actuator or switch that operates an intake door. The climate control system may be configured to operate a compressor setting, such as toggling the compressor on and off. The climate control system may be configured to control a ventilation mode, such as whether air is recirculated inside the cabin of the vehicle or if air is drawn from the environment. The climate control system may be configured to adjust a temperature of air flowing through a vent. Additionally, the climate control system may be configured to operate the various components to maintain a target temperature. The climate control system may be configured to operate the various components based on the solar load.

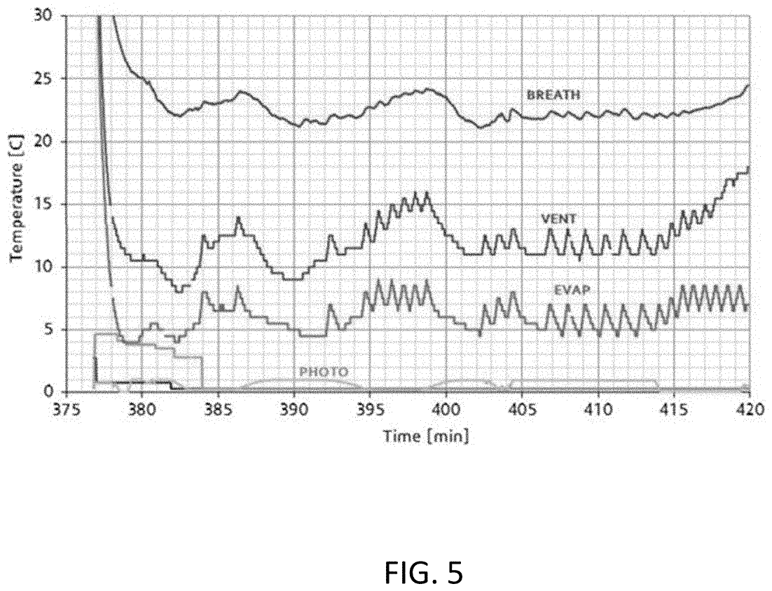

FIG. 5 depicts an example of a graph illustrating the behavior of the climate control system in response to the change in light entering the vehicle. The graph illustrates that a climate control setting is adjusted over time based on the solar load. The solar load may be represented by the line marked as “PHOTO.” The climate control settings include “EVAP” to indicate an air conditioning evaporator operated by the climate control system. The climate control settings include “VENT” to indicate a vent controlled by the climate control system.

The climate control system may be configured to operate the various components based on the solar load and the target temperature. For example, as the solar load increases (as shown by the line marked “PHOTO”), the temperature of the air conditioning evaporator decreases (as shown by the line market “EVAP”). In another example, as the solar load increases (as shown by the line marked “PHOTO”), the temperature of the air leaving the vent decreases (as shown by the line marked “VENT”). Additionally, and/or alternatively, as the solar load increases (as shown by the line marked “PHOTO”), the vent setting may be adjusted for a cooler air setting (as shown by the line marked “VENT”).

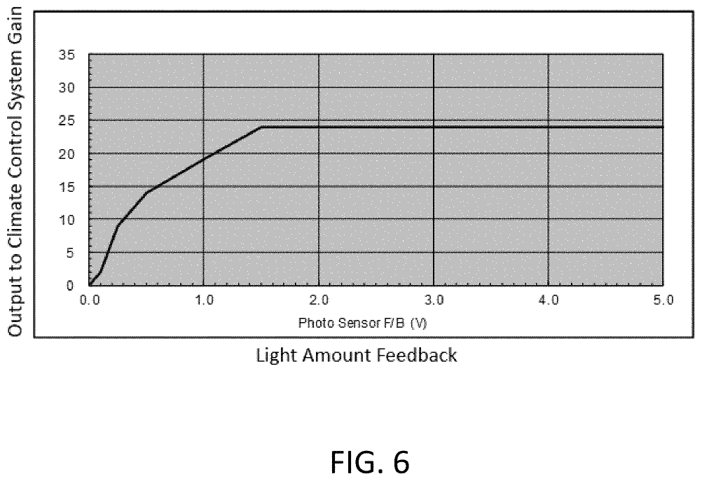

FIG. 6 depicts a diagram of a graph illustrating the relationship between the climate control system gain and the solar load on the vehicle. The graph illustrates that a climate control system gain is adjusted based on the voltage output of a photosensor or a camera. The voltage output of the photosensor or the camera may provide feedback indicating the intensity of the climate control system gain needed to maintain the target temperature. As the voltage of the output of the photosensor increases, the climate control system gain increases to maintain the target temperature.

The solar gain may be modified based on the solar load on the vehicle. A smaller solar load may result in a smaller solar gain. In turn, a smaller solar gain may result in a smaller adjustment of the climate control system. A greater solar load may result in a greater solar gain. A greater solar gain may result in a greater adjustment of the climate control system. The solar gain may be configured to adjust the intensity of the response of the climate control system.

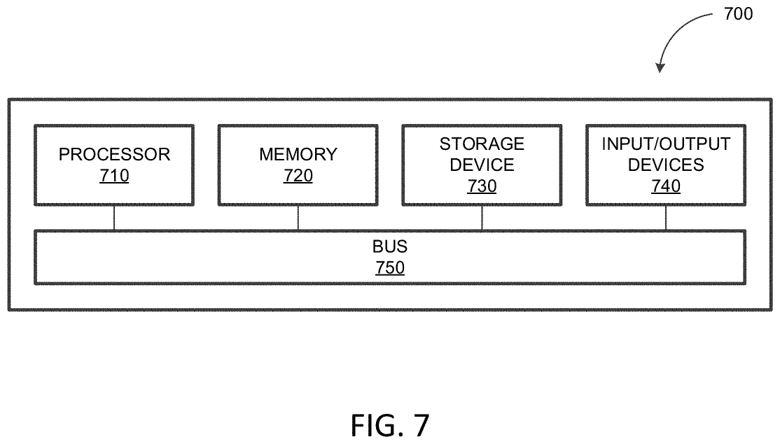

FIG. 7 depicts a block diagram illustrating a computing system 700 consistent with implementations of the current subject matter. Referring to FIGS. 1-7, the computing system 700 may be used to adjust a climate control setting based on a solar load. For example, the computing system 700 may implement a user equipment, a personal computer, or a mobile device.

As shown in FIG. 7, the computing system 700 may include a processor 710, a memory 720, a storage device 730, and an input/output device 740. The processor 710, the memory 720, the storage device 730, and the input/output device 740 may be interconnected via a system bus 750. The processor 710 is capable of processing instructions for execution within the computing system 700. Such executed instructions may implement one or more components of, for example, cross-cloud code detection. In some example embodiments, the processor 710 ay be a single-threaded processor. Alternately, the processor 710 can be a multi-threaded processor. The processor 710 is capable of processing instructions stored in the memory 720 and/or on the storage device 730 to display graphical information for a user interface provided via the input/output device 740.

The memory 720 is a computer-readable medium such as volatile or non-volatile that stores information within the computing system 700. The memory 720 may store data structures representing configuration object databases, for example. The storage device 730 is capable of providing persistent storage for the computing system 700. The storage device 730 may be a floppy disk device, a hard disk device, an optical disk device, or a tape device, or other suitable persistent storage means. The input/output device 740 provides input/output operations for the computing system 700. In some example embodiments, the input/output device 740 includes a keyboard and/or pointing device. In various implementations, the input/output device 740 includes a display unit for displaying graphical user interfaces.

According to some example embodiments, the input/output device 740 may provide input/output operations for a network device. For example, the input/output device 740 may include Ethernet ports or other networking ports to communicate with one or more wired and/or wireless networks (e.g., a local area network (LAN), a wide area network (WAN), the Internet, a public land mobile network (PLMN), and/or the like).

In some example embodiments, the computing system 700 may be used to execute various interactive computer software applications that can be used for organization, analysis and/or storage of data in various formats. Alternatively, the computing system 700 may be used to execute any type of software applications. These applications may be used to perform various functionalities, e.g., planning functionalities (e.g., generating, managing, editing of spreadsheet documents, word processing documents, and/or any other objects, etc.), computing functionalities, communications functionalities, etc. The applications may include various add-in functionalities or may be standalone computing items and/or functionalities. Upon activation within the applications, the functionalities may be used to generate the user interface provided via the input/output device 740. The user interface may be generated and presented to a user by the computing system 700 (e.g., on a computer screen monitor, etc.).

The technical advantages presented herein may result in an efficient way to use a camera to detect a solar load on a vehicle. Unlike previous solutions, no redundancy of hardware is required as the camera is configured to detect a change in the amount of light entering the vehicle and the intensity of the light entering the vehicle. Furthermore, calculating the solar load can provide feedback to a climate control system to better maintain the temperature of the vehicle at a target temperature.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A system comprising:
a camera configured to determine a change in an amount of light entering a vehicle;
a processor;
a non-transitory computer-readable storage medium storing instructions that, when executed by the processor, cause the processor to perform operations comprising:
in response to the camera determining the change in the amount of light entering the vehicle, calculating a solar load based on data from the camera, the solar load indicative of an intensity of light entering the vehicle; and
in response to calculating the solar load, adjusting a climate control system in the vehicle based on the solar load and a target temperature within the vehicle, the climate control system configured to maintain the target temperature.

2. The system of claim 1, wherein the camera is an advanced driver assistance camera with a light meter to adjust an iris setting associated with a lens of the camera, the iris setting indicative of the solar load, and wherein data from the camera is the iris setting.

3. The system of claim 1, wherein the solar load is calculated based on light setting data from the camera and the light setting data is converted to the solar load using a transfer function.

4. The system of claim 1, wherein calculating the solar load includes calculating the intensity of the light entering the vehicle based on at least one of aperture setting data from the camera, ISO setting data from the camera, and shutter speed data from the camera.

5. The system of claim 4, wherein calculating the solar load is further based on measuring the intensity of light traveling at ultraviolet frequencies.

6. The system of claim 4, wherein calculating the solar load is further based on measuring the intensity of light traveling at infrared frequencies.

7. The system of claim 4, wherein calculating the solar load is further based on measuring the intensity of light traveling at visible-light frequencies.

8. The system of claim 1, wherein the camera determines the change in light entering the vehicle based on at least one of an iris setting, a light setting, an ISO setting, an aperture setting, and a shutter speed.

9. The system of claim 1, wherein adjusting the climate control system includes at least one of adjusting an applied blower motor voltage, an intake door, a compressor setting, a ventilation mode, and an air temperature leaving a vent.

10. The system of claim 1, wherein the climate control system adjusts to a cooler temperature setting based on a higher solar load and wherein the climate control system adjusts to a higher temperature setting based on a lower solar load.

11. A non-transitory computer-readable storage medium storing instructions that, when executed by a processor, cause the processor to perform operations comprising:
in response to a camera determining a change in an amount of light entering a vehicle, calculating a solar load based on data from the camera, the solar load indicative of an intensity of light entering the vehicle; and
in response to calculating the solar load, adjusting a climate control system in the vehicle based on the solar load and a target temperature within the vehicle, the climate control system configured to maintain the target temperature.

12. The non-transitory computer-readable storage medium of claim 11, wherein the camera is an advanced driver assistance camera with a light meter configured to adjust an iris setting associated with a lens of the camera, the iris setting indicative of the solar load, and wherein data from the camera is the iris setting.

13. The non-transitory computer-readable storage medium of claim 11, wherein the solar load is calculated based on light setting data from the camera and the light setting data is converted to the solar load using a transfer function.

14. The non-transitory computer-readable storage medium of claim 11, wherein calculating the solar load includes calculating the intensity of light entering the vehicle based on at least one of aperture setting data from the camera and shutter speed data from the camera.

15. The non-transitory computer-readable storage medium of claim 14, wherein calculating the solar load is further based on measuring the intensity of light traveling at infrared frequencies.

16. The non-transitory computer-readable storage medium of claim 14, wherein calculating the solar load is further based on measuring the intensity of light traveling at ultraviolet frequencies.

17. The non-transitory computer-readable storage medium of claim 14, wherein calculating the solar load is further based on measuring the intensity of light traveling at visible-light frequencies.

18. The non-transitory computer-readable storage medium of claim 11, wherein the camera determines the change in the amount of light entering the vehicle based on at least one of an iris setting, a light setting, an aperture setting, and a shutter speed.

19. The non-transitory computer-readable storage medium of claim 11, wherein adjusting the climate control system includes at least one of adjusting an applied blower motor voltage, an intake door, a compressor setting, a ventilation mode, and an air temperature leaving a vent.

20. A computer-implemented method comprising:
in response to a camera determining a change in an amount of light entering a vehicle, calculating a solar load based on data from the camera, the solar load indicative of an intensity of light entering the vehicle; and
in response to calculating the solar load, adjusting a climate control system in the vehicle based on the solar load and a target temperature within the vehicle, the climate control system configured to maintain the target temperature.
